(19) United States
(12) Patent Application Publication
(10) Pub. No.: US 2008/0162978 A1
(43) Pub. Date: Jul. 3, 2008

(54) POOL COUNTING CIRCUIT OF A MICROCONTROLLER AND THE POOL COUNTING METHOD THEREOF

(75) Inventors: WEN-CHI HSU, CHANGHUA COUNTY (TW); SHU-HUA KUO, HSINCHU CITY (TW); HAN-TSUNG LIN, TAICHUNG CITY (TW); MAO-SHIH LI, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: HOLTEK SEMICONDUCTOR INC., HSINCHU (TW)

(21) Appl. No.: 11/846,720

(22) Filed: Aug. 29, 2007

(30) Foreign Application Priority Data
Dec. 27, 2006 (TW) 95149333

(51) Int. Cl. G06F 9/46; G06F 1/04

(52) U.S. Cl. 713/600; 718/100

(57) ABSTRACT

A microcontroller of the present invention integrates a plurality of independent counters of corresponding operation functions into a pool counting circuit and executes each corresponding operation function based on each of different operation cycles. Therefore, the present invention can increase the circuit pool level and reduce the power consumption and the chip size.

### BACKGROUND OF THE INVENTION

1. Field of the Invention

The present invention relates to a microcontroller, and more specifically to a pool counting circuit of a microcontroller and the pool counting method thereof.

2. Description of the Prior Art

For application of current microcontrollers, all counting circuits are independent, that is, the previous microcontroller has to independently use a corresponding counting circuit to count each operation cycle of various operation functions when executing selected operation function. In this previous embodiment, such microcontroller is easy to be controlled.

However, some operation functions may be used only within a certain period in the microcontroller, thus, when the operation functions aren't executed, the counting circuits corresponding to the operation functions are idle. So such microcontroller has great chip size and high power consumption. If operation cycles corresponding to each operation function of the microcontroller are analyzed and programmed and the independent counters are integrated, the microcontroller will have the smaller chip size and the lower power consumption.

Hence, the inventors of the present invention believe that these shortcomings above are able to be improved upon and suggest the present invention which is of a reasonable design and is an effective improvement based on deep research and thought.

### SUMMARY OF THE INVENTION

A microcontroller of the present invention integrates a plurality of independent counters of corresponding operation functions into a pool counting circuit and executes each corresponding operation function based on each of different operation cycles.

The pool counting circuit of the present invention comprises a multiplexer, a counting unit, a control unit and a plurality of working units. The multiplexer connects to the counting unit and the control unit and multiplexes to pass one of working clocks according to the control signal outputted by the control unit. The counting unit connects to the control unit and is controlled by the control unit to count the operation cycles based on the passed working clock. The control unit connects to the working units and provides the control signal to control the multiplexer according to the counting result of the counting unit. Each of the working units executes one corresponding operation function according to the control of the control unit.

For further understand the features and technical contents of the present invention, please refer to the following detailed description and drawings related to the present invention. However, the drawings are only to be used as references and explanations, and not to limit the present invention.

### BRIEF DESCRIPTION OF THE DRAWINGS

FIG. 1 is a block diagram of a pool counting circuit of a microcontroller of the present invention;

FIG. 2 is a flow chart of a pool counting method of a microcontroller of the present invention.

### DETAILED DESCRIPTION OF THE INVENTION

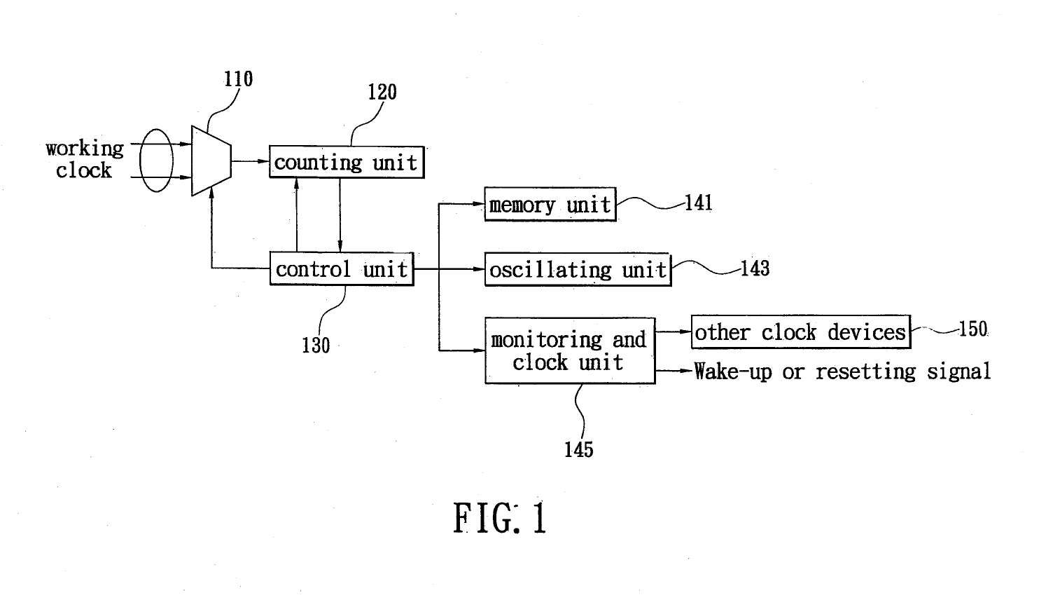

Referring to FIG. 1, a block diagram of a pool counting circuit of a microcontroller of the present invention is shown. The pool counting circuit includes a multiplexer 110, a counting unit 120, a control unit 130 and a plurality of working units. The multiplexer 110 connects to the counting unit 120 and the control unit 130, and the control unit 130 connects to the working units.

The multiplexer 110 provides a plurality of switch routes and opens one of the switch routes based on a control signal so as to pass one of a plurality of working clocks to the counting unit 120, wherein each switch route is associated with one working clock.

The counting unit 120 is controlled by the control unit 130 and receives the passed working clock from the multiplexer 110 for further counting, and then transmits a counting result to the control unit 130. Each working clock has a corresponding operation cycle, and the memory unit 141 can be a read only memory (ROM).

The control unit 130 controls the multiplexer 110 to switch on one of the switch routes according to one of the various operation cycles. After elapsing one operation cycle, the counting unit 120 transmits the corresponding counting result to the control unit 130, and then the control unit 130 outputs a control signal to control the multiplexer 110. The control unit 130 drives one of the working units to operate based on the counting result and provides counting status to the counting unit 120 according to the operation status of the microcontroller. Each operation cycle associated with an operation function of a working unit.

The working units include a memory unit 141, an oscillating unit 143 and a monitoring and clock unit 145. The memory unit 141 associates with a function option loading. When the microcontroller executes the operation function loading, the control unit 130 controls the multiplexer 110 to pass a working clock associated with the function option loading. Then, the microcontroller can read a function setting from the memory unit 141, for further loading and executing the function setting and driving the counting unit 120 to count the loading time of the function setting.

The oscillating unit 143 associates with an oscillation stabilization. When the microcontroller executes the oscillation stabilization, the control unit 130 controls the multiplexer 110 to pass a working clock associated with the oscillation stabilization. Then, the oscillator set in the oscillating unit 143 can be stabilized, and the counting unit 120 counts the period spent on the stabilization to generate an oscillation stabilization time.

The monitoring and clock unit 145 associates with a monitoring function and a multifunction clock generation. When the microcontroller executes the monitoring function, the control unit 130 controls the multiplexer 110 to open a working clock of the monitoring function up to pass. Then, the monitoring device (not be shown) set in the monitoring and clock unit 145 can detect the operation status of the microcontroller which is executing a main program, for further controlling the microcontroller to execute the main program continuously, and waking up or resetting the microcontroller. When the microcontroller executes the multifunction clock generation, the control unit 130 controls the multiplexer 110 to open a working clock of the multifunction clock generation up to pass. Then, the clock generating device (not be shown) set in the monitoring and clock unit 145 outputs multiple clocks to other clock devices 150 connected therewith.

The monitoring device can be a watch dog circuit, the other clock devices 150 can be a panel drive circuit, a timer, a buzzer, and so on.

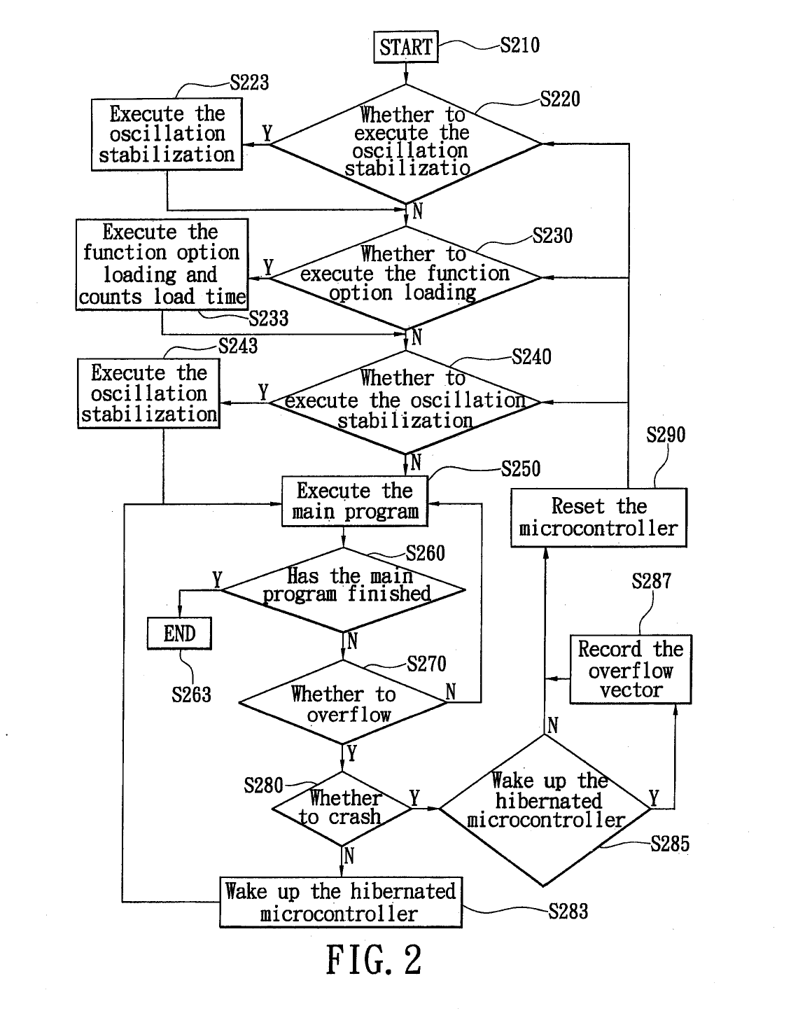

Referring to FIG. 2, which shows that the pool counting circuit of the microcontroller provides operation cycles to drive the working units, wherein FIG. 2 is a flow chart of a pool counting method of a microcontroller of the present invention.

Firstly, after the power supply of the microcontroller is activated, a plurality of working clocks in the microcontroller are transmitted to the multiplexer 110, as the step S210. The control unit 130 judges whether the microcontroller executes the oscillation stabilization for the first time according to the settings of users, as the step S220.

When executing the oscillation stabilization, the microcontroller has to spend the first oscillation time to stabilize an oscillation frequency of certain oscillator set in the oscillating unit 143. Hence, the control unit 130 outputs a control signal to the multiplexer 110 and controls the multiplexer 110 to pass a working clock corresponding to the oscillation stabilization to the counting unit 120, and then the oscillating unit 143 can execute the oscillation stabilization, as the step S223. Simultaneously, the control unit 130 controls the counting unit 120 to count the first oscillation time, and the control unit 130 judges whether the microcontroller executes the function option loading after the first oscillation time is elapsed, as the step S230.

Reversely, when the microcontroller dose not execute the oscillation stabilization, the control unit 130 judges directly whether the microcontroller executes the function option loading, as the step S230.

When executing the function option loading, the microcontroller has to execute a function setting. Hence, the control unit 130 outputs a control signal to the multiplexer 110 and controls the multiplexer 110 based on the control signal to pass a working clock corresponding to the function option loading to the counting unit 120 for further loading the microcontroller with the function setting from the memory unit 141, as the step S233. Simultaneously, the control unit 130 controls the counting unit 120 to count the loading time of the function setting and then judges whether the microcontroller executes the oscillation stabilization again after the loading time is elapsed, as the step S240.

When the microcontroller dose not execute the function option loading, the control unit 130 judges directly whether the microcontroller executes the oscillation stabilization again, as the step S240.

When executing the oscillation stabilization again, the microcontroller has to spend a second oscillation time on stabilizing the oscillation frequency of the oscillator set in the oscillating unit 143. Hence, the control unit 130 outputs a control signal to the multiplexer 110 to control the multiplexer 110 to pass a working clock corresponding to the oscillation stabilization to the counting unit 120, and then the oscillating unit 143 can execute the oscillation stabilization, as the step S243. Simultaneously, the control unit 130 controls the counting unit 120 to count the second oscillation time, and then further executes the main program after the second oscillation time is elapsed, as the step S250.

Reversely, when the microcontroller dose not execute the oscillation stabilization again, the control unit 130 executes directly the main program, as the step S250.

When the microcontroller executes the main program, the control unit 130 judges continuously whether the executed main program is finished at the step S260. Synchronously, the control unit 130 drives the monitoring and clock unit 145 to execute the multifunction clock generation or the monitoring function.

When the microcontroller executes the multifunction clock generation, the control unit 130 outputs a control signal to the multiplexer 110 to control the multiplexer 110 to pass a working clock corresponding to the multifunction clock generation to the counting unit 120. Then, a clock generating device set in the monitoring and clock unit 145 products multiple clocks to the other clock devices 150. Furthermore, when the microcontroller executes the monitoring function, the control unit 130 drives the monitoring device set in the monitoring and clock unit 145 to execute the monitoring function, that is, the control unit 130 outputs a control signal to the multiplexer 110 to control the multiplexer 110 to pass a working clock of the monitoring function to the counting unit 120, and the monitoring and clock unit 145 can monitor the operation status of the microcontroller which is executing the main program.

When the monitoring device is executing the monitoring function, the counting unit 120 transmits the counting result to the control unit 130, and the control unit 130 judges whether the counting unit 120 overflows according to the operation status of the microcontroller, as the step S270. When the main program is executed, there are two operation statuses of the microcontroller which cause the counting unit 120 overflows, one is that the microcontroller crashes, and the other is that the microcontroller hibernates.

If the counting unit 120 doesn't overflow, the microcontroller continuously executes the main program normally, as the step S250. If the counting unit 120 overflows, the microcontroller may crash or hibernate. Thus, the control unit 130 further judges whether the microcontroller crashes or not, as the step S280.

When the microcontroller hibernates, the monitoring device of the monitoring and clock unit 145 outputs a wake-up signal to wake up the microcontroller, as the step S283. The waked microcontroller may execute the main program continuously according to the user's settings (as the step S250).

When the microcontroller crashes, the monitoring device of the monitoring and clock unit 145 outputs a resetting signal to reset the crashed microcontroller, as the step S290. According to user's setting, the control unit 130 judges whether to record the overflow vector while the microcontroller crashes, as the step S285. If necessary for recording the overflow vector, the control unit 130 records the overflow vector as the step S287 and then resets the microcontroller. If not, the control unit 130 resets the microcontroller directly as the step S290.

If the reset microcontroller has not finished the main program, the process proceeds to the step S220, S230 or S240.

Finally, the control unit 130 always judges continually whether the microcontroller has finished executing the main program. If the main program is finished, the control unit 130 stops all operations defined in the main program immediately, as the step S263.

Advantage of the present invention is that counters of corresponding operation functions are integrated into a counting unit.

Another advantage of the present invention is that the counting unit can perform a plurality of operation functions based on the various operation cycles of operation functions.

A third advantage of the present invention is to increase the circuit pool level, reduce the power consumption and reduce the chip size.

What is disclosed above are only the preferred embodiments of the present invention, and therefore it is intended that the present invention not be limited to the particular embodiment disclosed. It should be understood by those skilled in the art that various equivalent changes may be made depending on the specification and the drawings of present invention without departing from the scope of the present invention.

What is claimed is:

1. A pool counting method, integrating a plurality of independent counters of corresponding operation functions of a microcontroller into a pool counting unit and executing each of the operation functions based on each of corresponding operation cycles of the operation functions, the step of executing a monitoring function of the operation functions comprising:
executing a main program;
judging whether the counting unit overflows according to the operation status of the executing of the main program;
judging whether the microcontroller crashes, hibernates or normally operates based on the step of judging whether the counting unit overflows or not; and
judging whether to reset or wake up the microcontroller or continuously executing the main program based on the step of judging whether the microcontroller crashes, hibernates or naturally operates.

2. The pool counting method as claimed in claim 1, wherein the microcontroller crashes or hibernates if the counting unit overflows.

3. The pool counting method as claimed in claim 1, wherein if the microcontroller crashes, reset the microcontroller by a resetting signal.

4. The pool counting method as claimed in claim 1, wherein if the microcontroller hibernates, wake up the microcontroller by a wake-up signal.

5. The pool counting method as claimed in claim 1, wherein if the microcontroller operates normally, continuously execute the main program.

6. The pool counting method as claimed in claim 1, wherein if the microcontroller crashes, judge whether to record an overflow vector.

7. A pool counting method, integrating a plurality of independent counters of corresponding operation functions of a microcontroller into a pool counting and executing each of the corresponding operation functions based on each of corresponding operation cycles of the operation functions, comprising:
inputting a plurality of working clocks into a multiplexer, each working clock relates to one of the operation functions and one of the operation cycles;
controlling the multiplexer to pass one of the working clocks based on each operation cycle so as to execute the corresponding operation function of the passed working clock and drive the counting unit to count; and
judging whether to execute next operation function based on which the selected operation cycle is finished.

8. The pool counting method as claimed in claim 7, wherein the operation functions comprise a function option loading, an oscillation stabilization, a monitoring function and a multifunction clock generation.

9. The pool counting method as claimed in claim 7, wherein the executed operation function is the function option loading which is for loading the microcontroller with a function setting from a memory unit and driving the counting unit to count a loading time.

10. The pool counting method as claimed in claim 7, wherein the executed operation function is the oscillation stabilization which is for stabilizing an oscillation frequency of an oscillating unit before the microcontroller executes another operation function.

11. The pool counting method as claimed in claim 7, wherein the executed operation function is the monitoring function which is for waking up or resetting the microcontroller according to the operation status of the microcontroller.

12. The pool counting method as claimed in claim 11, wherein the method further comprises waking up the microcontroller when the microcontroller hibernates.

13. The pool counting method as claimed in claim 11, wherein the method further comprises resetting the microcontroller when the microcontroller crashes.

14. The pool counting method as claimed in claim 13, wherein the method further comprises judging whether to record an overflow vector before resetting the microcontroller.

15. The pool counting method as claimed in claim 7, wherein the executed operation function is the multifunction clock generation which is for outputting multiple clocks to a plurality of clock devices.

16. A pool counting method, utilizing a counting unit to count the operation cycles of a plurality of operation functions and multiplexing and executing one of the operation functions, the method comprising:
judging whether to execute an oscillation stabilization, and further judging whether to execute the function option loading;
executing a main program according to the step of judging whether to execute the function option loading;
judging whether the microcontroller overflows according to the operation status of the main program; and
judging whether to execute the main program continuously, wake up the microcontroller or reset the microcontroller according to the step of judging whether the microcontroller overflows.

17. The pool counting method as claimed in claim 16, wherein the method further comprises if needing to stabilize an operation frequency of an oscillating unit, that is, if executing the oscillation stabilization, the microcontroller judges whether to execute the function option loading after executing an oscillating cycle of the operation frequency, and if not, the microcontroller judges whether to execute the function option loading directly.

18. The pool counting method as claimed in claim 16, wherein the method further comprises if needing to execute the function option loading, the microcontroller executes the main program after executing the function option loading, and if not, the microcontroller executes the main program directly.

19. The pool counting method as claimed in claim 16, wherein the method further comprises:
judging whether to execute the oscillation stabilization again according to the step of judging whether to execute the function option loading; and
executing the main program according to the step of judging whether to execute the oscillation stabilization again.

20. The pool counting method as claimed in claim 16, wherein the method further comprises if no overflow, the microcontroller executes the main program continuously.

21. The pool counting method as claimed in claim 16, wherein the method further comprises resetting the microcontroller if the microcontroller overflows and crashes.

22. The pool counting method as claimed in claim 21, wherein the method further comprises judging whether to record an overflow vector and then resetting the microcontroller.

23. The pool counting method as claimed in claim 16, wherein the method further comprises waking up the microcontroller if the microcontroller overflows and hibernates.

24. A pool counting circuit of a microcontroller, integrating a plurality of independent counters of corresponding operation functions of the microcontroller into a pool counter, and executing each of the operation functions based on each of corresponding operation cycles of the operation functions, comprising:
a multiplexer for multiplexing to pass one of working clocks based on a control signal;
a counting unit for counting based on the passed working clock and the corresponding operation cycle of the passed working clock;
a control unit for controlling the counting unit and providing the control signal based on the counting result;
a plurality of working units for executing the operation function of the passed working clock based on the control of the control unit.

25. The pool counting circuit of a microcontroller as claimed in claim 24, wherein the working units comprise a memory unit, an oscillating unit and a monitoring and clock unit.

26. The pool counting circuit of a microcontroller as claimed in claim 25, wherein one of the operation functions is a function option loading that is for loading the microcontroller with a function setting read from the memory unit and then driving the counting unit to count a loading time.

27. The pool counting circuit of a microcontroller as claimed in claim 25, wherein one of the operation functions is an oscillation stabilization that is for stabilizing the oscillation frequencies of the oscillating unit before the microcontroller executes another operation function.

28. The pool counting circuit of a microcontroller as claimed in claim 25, wherein one of the operation functions is a monitoring function which is for which the monitoring and clock unit wakes up or resets the microcontroller and drives the microcontroller to execute a main program continuously according to the operation states of the microcontroller.

29. The pool counting circuit of a microcontroller as claimed in claim 25, wherein one of the operation functions is a multifunction clock generation which is for which the monitoring and clock unit outputs multiple clocks to a plurality of clock devices.
